(19) United States
(12) Patent Application Publication
(10) Pub. No.: US 2024/0345872 A1
(43) Pub. Date: Oct. 17, 2024

(54) Processor System for a Vehicle, and Method for Monitoring a Process State After a Remote Software Update

(71) Applicant: Bayerische Motoren Werke Aktiengesellschaft, Muenchen (DE)

(72) Inventors: Jaakko AHO, Ulm (DE); Kazi Khaled AL ZAHID, Oberschleissheim (DE); Vito MAGNANIMO, Muenchen (DE)

(21) Appl. No.: 18/292,763

(22) PCT Filed: Aug. 23, 2022
(86) PCT No.: PCT/EP2022/073474

§ 371 Date: Jan. 26, 2024

(30) Foreign Application Priority Data
Oct. 4, 2021 (DE) 10 2021 125 672.0

(51) Int. Cl. G06F 9/48; B60W 60/00; G06F 8/65; G06F 11/30

(52) U.S. Cl. CPC G06F 9/485; B60W 60/001; G06F 8/65; G06F 11/3013

(57) ABSTRACT

A processor system for a vehicle, in particular a motor vehicle. The processor system includes a state manager module designed to manage states with respect to processes; an execution manager module designed to output instructions for starting and stopping the processes; and a safety module for remote software updates, said safety module being designed to receive an error signal which indicates an erroneous remote software update. In response to receiving the error signal, the safety module is designed to: output instructions to the state manager module, said instructions ordering a changeover to a specified state, wherein at least one process is not allowed to be executed in the specified state; receive a process list with processes which have been started from the execution manager module; and output an abort signal in order to stop the at least one process if the process list comprises the at least one process.

### BACKGROUND AND SUMMARY

The present disclosure relates to a processor system for a vehicle, a driver assistance system having such a processor system, a vehicle having such a driver assistance system, and a method for monitoring a process state following a remote software update. In particular, the present disclosure relates to a safety of assistance systems of a vehicle in the case of a failed remote software update.

The development of vehicle assistance systems is becoming ever more important. Such assistance systems are additional electronic devices in vehicles for assisting the driver in certain driving situations. Exemplary assistance systems include a parking aid, automated lights, traffic sign identification, and driver assistance systems for automated driving. With regard to the latter, automated driving can be implemented with different degrees of automation. Exemplary degrees of automation include assisted, partly automated, highly automated or fully automated driving.

These days, the software of such assistance systems can be updated by means of a remote software update (RSU). The software is updated by way of a wireless connection between the vehicle and a server within the scope of the remote software update. However, if the remote software update fails, it may be necessary for reasons of safety to at least partly block the corresponding assistance function from use. Then, it may be necessary to visit a workshop in order to lift this block.

However, this block may be circumvented or not be effective in certain situations, and the assistance function is carried out despite the block being present. As a result, safety risks may arise if the assistance function is operated with faulty software.

It is an object of the present disclosure to specify a processor system for a vehicle, a driver assistance system having such a processor system, a vehicle having such a driver assistance system, and a method for monitoring a process state following a remote software update, which are able to minimize safety risks in the case of a failed remote software update. In particular, it is an object of the present disclosure to reliably prevent an execution of certain processes in the case of a failed remote software update.

This object is achieved by the subject matter of the present disclosure. Advantageous configurations are further specified in the present disclosure.

According to an aspect of the present disclosure, a processor system for a vehicle, in particular a motor vehicle, is specified. The processor system comprises a machine state manager (MSM) module configured to manage states in relation to processes; an execution manager (EM) module configured to output an instruction for starting and stopping the processes; and a safety module for remote software updates (remote software update degradation handler, RSU DH) configured to receive a degradation signal (DS) specifying a failed remote software update. Upon reception of the degradation signal, the safety module is configured to:
output an instruction to the machine state manager module instructing a change (in particular of the machine state manager module and/or a software platform, to which the processor system or the processes belong) to a predetermined state, with an execution of at least one process not being allowed in the predetermined state;
receive a process list with started processes from the execution manager module; and
output a termination signal for stopping the at least one process should the process list comprise the at least one process.

According to the present disclosure, the degradation signal is not transmitted directly to the machine state manager module but to a safety-relevant module which is responsible for triggering and monitoring the blocking of specific processes. The safety module then requests that the machine state manager module change its state to a predetermined state which is expected following the reception of a degradation signal on account of a failed remote software update. An execution of certain processes is not allowed in this state. The safety module monitoring of this blocking of certain processes is implemented by virtue of the safety module receiving a list of started processes from the execution manager module, which is to say the module responsible for starting the processes. Should the execution manager module start a different list of processes from what is allowed, the problem is reported to a watchdog, for example via a heartbeat. Hence, the safety module checks whether the state was correctly set by way of an “indirect measurement”. The configuration according to the present disclosure is particularly advantageous if the machine state manager module is not qualified (e.g., QM pursuant to standard ISO 26262).

As a result, an execution of certain processes can be reliably prevented in the case of a failed remote software update, whereby it is possible to minimize safety risks in the case of a failed remote software update.

The machine state manager module, the execution manager module and the safety module can be software modules which comprise a program code for carrying out the described functionalities. The machine state manager module and/or the execution manager module and/or the safety module can be realized in a common hardware module, for instance a processor or a CPU. Alternatively thereto, the machine state manager module and/or the execution manager module and/or the safety module may each be realized in separate hardware modules.

The machine state manager module manages various states for example of a software platform to which the processes belong. By way of example, the various states can be “init”, “running”, “shutdown”, and the predetermined state (e.g., “PlatformOnly”).

The execution manager module is configured to start processes in accordance with the state given by the machine state manager module.

The safety module provides and manages information in relation to a failed remote software update. In particular, the safety module specifies whether the system should be and/or remain in the predetermined state (e.g., “PlatformOnly”). The machine state manager module can query this information from the safety module and can accordingly bring the system into the predetermined state. Hence, the execution manager module also knows which processes should/may be started. Subsequently, the safety module monitors whether the execution manager module in fact only starts the allowed processes.

The term “remote software update”, as used within the scope of the present disclosure, relates to a software update via a wireless connection between the vehicle and a central unit, such as a server or backend.

For example, the wireless connection can be implemented using a cellular network. To this end, the vehicle may comprise a communications module that is able to communicate wirelessly in a cellular network via local networks or local area networks (LANs), such as wireless LAN (Wi-Fi/WLAN), or via wide area networks (WANs), such as Global System for Mobile Communication (GSM), General Package Radio Service (GPRS), Enhanced Data Rates for Global Evolution (EDGE), Universal Mobile Telecommunications System (UMTS), High Speed Downlink/Uplink Packet Access (HSDPA, HSUPA), Long-Term Evolution (LTE), or World Wide Interoperability for Microwave Access (WIMAX). Communication via further conventional communications technologies, for example 5G mobile radio systems, is possible.

The processor system preferably comprises (or is) an electronic control unit (ECU) or is contained in an electronic control unit. Electronic control units (ECUs) are electronic modules used in vehicles for open-loop or closed-loop control of very different processes and functions. By way of example, electronic control units are used to control fuel injection, comfort functions, safety systems, and/or driver assistance systems. The electronic control units may be networked via a data bus in order to be able to communicate with one another. By way of example, the electronic control units can interchange information about operating states of the vehicle and further relevant data relating to the vehicle via the data bus.

The term “process”, as used within the scope of the present disclosure and as is known to a person skilled in the art, is a computer program at runtime. In particular, a process is a specific instantiation of a program. A process may also be referred to as “task” or “program entity”.

A processor is a programmable arithmetic unit, which is to say a machine or an electronic circuit, which controls other elements according to transmitted commands and drives forward an algorithm (process) in the process.

A process list having processes which should/may be started in the predetermined state is preferably stored in a configuration module (configuration time) for example of the safety module. The termination signal is output if the safety module recognizes that a process not contained in the list of allowed processes has been started.

Preferably, the processor system comprises a nonvolatile storage module, wherein the safety module is configured to store the degradation signal in the nonvolatile storage module. In particular, the degradation signal and/or information relating to the failed remote software update may be stored in the nonvolatile storage module, with the result that this information still is available even in the case of a restart of the processor system, and an activation of the blocked processes or functions is prevented.

The nonvolatile storage module may comprise a nonvolatile storage such as a flash memory, magnetic media, for example a hard disk drive, or an optical memory, etc., or combinations thereof.

Preferably, the processor system also comprises a monitoring module configured to:
receive the termination signal from the safety module; and
initiate a shutdown of at least a part of the processor system upon reception of the termination signal.

The monitoring module preferably is a platform health management (PHM) module. In some embodiments, the monitoring module, especially the PHM module, can be a soft watchdog.

Preferably, the monitoring module is configured to initiate the shutdown by means of a heartbeat to a watchdog.

The term “heartbeat”, as used within the scope of the present disclosure, relates to a network connection between two (or more) processors in a cluster, for notifying one another to the effect that they are operational and still able to fulfill their tasks.

The term “watchdog”, as used within the scope of the present disclosure, relates to a circuit or a module which triggers a reset on account of the degradation signal so that the processor system can carry out its tasks again.

Preferably, the execution manager module is configured to start the safety module, especially upon a start of the processor system. In particular, the execution manager module may be configured to start some, especially all, modules of the processor system.

If the execution manager module does not start the safety module, which is to say a fault is present, the monitoring module is able to signal this, for example to an external watchdog on a different processor of the processor system. To signal this, the monitoring module can for example stop the heartbeat. If the heartbeat is stopped, the watchdog or the other processor can trigger an at least partial shutdown of the processor system.

In some embodiments, the machine state manager module can be indicated by QM pursuant to standard ISO 26262.

Additionally or alternatively, the execution manager module can be indicated by ASIL A, ASIL B, ASIL C, or ASIL D pursuant to standard ISO 26262.

Additionally or alternatively, the safety module can be indicated by ASIL A, ASIL B, ASIL C, or ASIL D pursuant to standard ISO 26262.

Additionally or alternatively, the monitoring module can be indicated by ASIL A, ASIL B, ASIL C, or ASIL D pursuant to standard ISO 26262.

Additionally or alternatively, the degradation signal can be indicated by ASIL A, ASIL B, ASIL C, or ASIL D pursuant to standard ISO 26262.

Hence, it is not necessary to qualify the entire life cycle management on the processor having the machine state manager module, the execution manager module, the safety module, and the monitoring module, whereby it is possible to reduce costs. In particular, it is possible to implement only the (small) safety module, which indirectly monitors deviations from the expected state following an RSU degradation.

Standard ISO 26262 defines a risk classification scheme, specifically the “automotive safety integrity level” (ASIL). This classification supports a definition of safety requirements. The ASIL is created by a risk analysis of a potential hazard, to be precise by virtue of considering a degree of severity, an exposure and a controllability of an operating scenario of a vehicle. There are four ASILs provided by standard ISO 26262: ASIL A, ASIL B, ASIL C, and ASIL D.

ASIL D dictates the greatest integrity requirements and ASIL A dictates the lowest integrity requirements. Hazards identified as QM (“quality management”) do not specify any safety requirements. Ensuring the integrity requirements defined by standard ISO 26262 may represent a great challenge in the development of assistance functions, for example for (partly) autonomous driving.

Preferably, the machine state manager module, the execution manager module, and the safety module (and optionally the monitoring module) are comprised in a single SoC-based (system-on-a-chip-based) processor (or CPU).

In general, a system-on-a-chip is understood to mean an integration of all or some of the functions of a programmable electronic system on a chip.

Preferably, the at least one process relates to a driving function for automated driving.

A vehicle performing automated driving steers and/or brakes and/or accelerates independently on the basis of a driving strategy. The driving strategy may be determined on the basis of surround data from the surround sensor system, state of the road, traffic situation, weather, etc. Implementation of the determined driving strategy is performed by the drive, the steering system, and/or the brakes.

A driver assistance system for automated driving of a vehicle is specified according to a further aspect of the present disclosure. The driver assistance system comprises a processor system according to the embodiments of the present disclosure.

Within the scope of the document, the term “automated driving” can be understood to mean driving with automated longitudinal or transverse guidance or autonomous driving with automated longitudinal and transverse guidance. For example, the automated driving may relate to relatively long-term driving on the highway or time-limited driving within the scope of parking or maneuvering. The term “automated driving” comprises automated driving with any desired degree of automation. Exemplary degrees of automation are assisted, partly automated, highly automated or fully automated driving. These degrees of automation were defined by the German Bundesanstalt für Straβenwesen [Federal Highway Research Institute] (BASt) (see BASt publication “Forschung kompakt”, edition November 2012).

In the case of assisted driving, the driver permanently performs the longitudinal or transverse guidance while the system adopts the respective other function within certain limits. In the case of partly automated driving (TAF), the system adopts the longitudinal and transverse guidance for a certain period of time and/or in specific situations, wherein the driver must permanently monitor the system, like in the case of assisted driving. In the case of highly automated driving (HAF), the system adopts the longitudinal and transverse guidance for a certain period of time without the driver being required to permanently monitor the system; however, the driver must be able to take over the vehicle guidance within a certain period of time. In the case of fully automated driving (VAF), the system can automatically deal with driving in all situations for a specific application; a driver is no longer required for this application.

The aforementioned four degrees of automation correspond to SAE Levels 1 to 4 of standard SAE J3016 (SAE—Society of Automotive Engineering). For example, highly automated driving (HAF) corresponds to Level 3 of standard SAE J3016. Furthermore, the SAE J3016 additionally provides SAE Level 5 as the highest degree of automation, which is not contained in the definition by the BASt. SAE Level 5 corresponds to driverless driving, in which the system can automatically deal with all situations like a human driver during the entire trip; in general, a driver is no longer required.

According to a further aspect of the present disclosure, a vehicle, in particular a motor vehicle, is specified. The vehicle comprises the processor system and/or the driver assistance system according to the embodiments of the present disclosure.

The term vehicle comprises automobiles, trucks, buses, motorhomes, motorbikes, etc., which serve to convey persons, goods, etc. In particular, the term comprises motor vehicles for conveying persons.

According to a further aspect of the present disclosure, a method is specified for monitoring a process state following a remote software update in a vehicle. The method comprises receiving, by a safety module for remote software updates, a degradation signal specifying a failed remote software update; outputting, by the safety module, an instruction to a machine state manager module configured to manage states in relation to processes, with the instruction instructing a change to a predetermined state, and with an execution of at least one process not being allowed in the predetermined state; receiving, by the safety module, a process list with started processes from an execution manager module configured to output an instruction for starting and stopping the processes; and outputting, by the safety module, a termination signal for stopping the at least one process should the process list comprise the at least one process.

The method can implement the aspects of the processor system described in this document.

According to a further aspect of the present disclosure, a software (SW) program is specified. The SW program can be configured to be executed on one or more processors, and to thereby carry out the method for monitoring a process state following a remote software update, as described in this document.

According to a further aspect of the present disclosure, a storage medium is specified. The storage medium may comprise an SW program which is configured to be executed on one or more processors, and to thereby carry out the method for monitoring a process state following a remote software update, as described in this document.

According to a further aspect of the present disclosure, a software with program code for carrying out the method for monitoring a process state following a remote software update is to be executed when the software runs on one or more software-controlled devices.

### BRIEF DESCRIPTION OF THE DRAWINGS

Exemplary embodiments of the disclosure are depicted in the figures and described in more detail hereinbelow. In detail:

FIG. 1 schematically shows a remote software update according to embodiments of the present disclosure,

FIG. 2 schematically shows an electronic control unit for a vehicle according to embodiments of the present disclosure,

FIG. 3 schematically shows a processor for a vehicle according to embodiments of the present disclosure,

FIG. 4 schematically shows a vehicle having a driver assistance system for automated driving according to embodiments of the present disclosure, and

FIG. 5 shows a flowchart of a method for monitoring a process state following a remote software update according to embodiments of the present disclosure.

### DETAILED DESCRIPTION OF THE DRAWINGS

Unless specified otherwise, the same reference signs are used hereinbelow for the same elements and elements with the same effect.

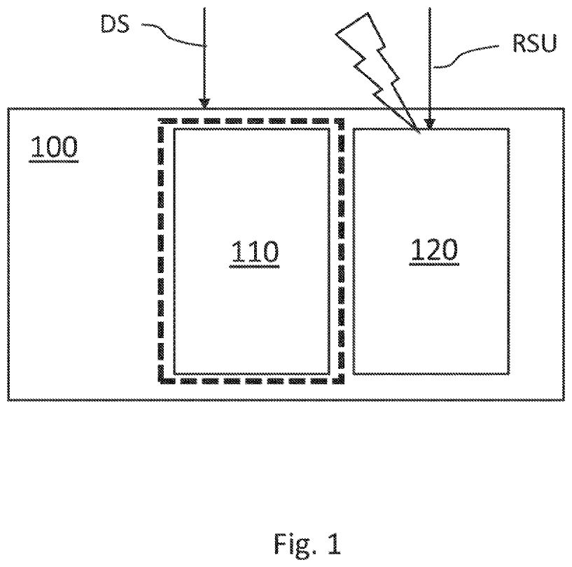

FIG. 1 schematically shows a remote software update (RSU) according to embodiments of the present disclosure.

An electronic control unit 100 with a current partition 110 and a mirrored partition 120 is shown in exemplary fashion. The mirrored partition 120 is updated via a wireless connection between the vehicle and a central unit, for instance a server or backend. For example, the wireless connection can be implemented using a cellular network, for instance a 5G network.

Now, if a fault arises during the remote software update or if the remote software update was not successful, this circumstance is indicated to the electronic control unit by means of a degradation signal DS. In particular, it may be the case that no safety-relevant function may be started in the case of a faulty update. The electronic control unit 100 may start up, but the functions cannot be carried out (increased debugging).

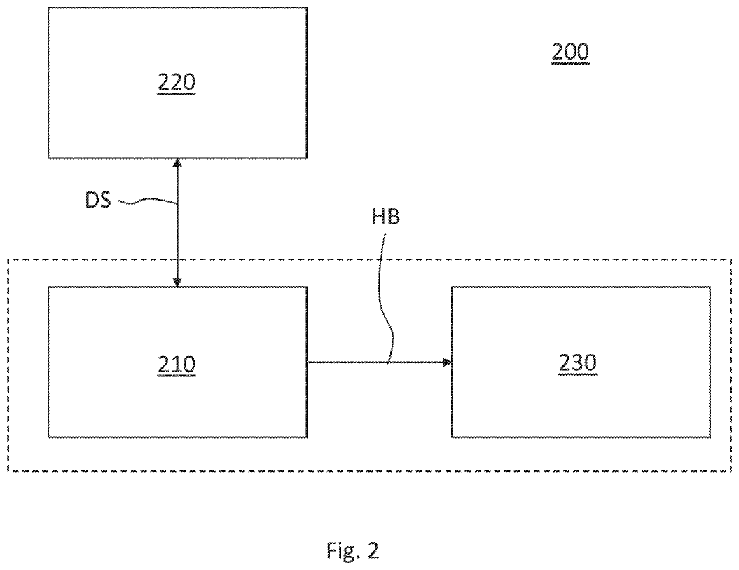

FIG. 2 schematically shows an exemplary electronic control unit 200 for a vehicle according to embodiments of the present disclosure.

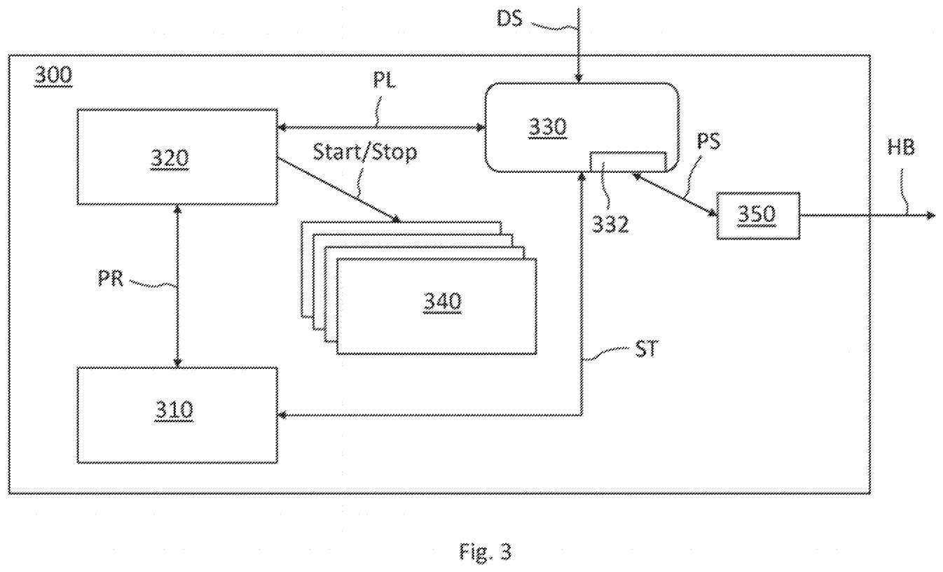

The electronic control unit 200 comprises, or is, the processor system according to the embodiments of the present disclosure. In particular, the processor system comprises a first processor 210, which implements the triggering and monitoring the blocking of certain processes according to the present disclosure. An exemplary first process is shown in FIG. 3 and described in detail hereinbelow.

FIG. 2 also shows a second processor 210, which supplies the degradation signal DS to the first processor 210. The second processor 220 may be integrated in the processor system and/or the electronic control unit 200, or it may be an external processor. For example, the RSU degradation following the outage of an RSU cycle may be forced by the second processor 210, wherein the first processor 210 must maintain a certain state (e.g., PlatformOnly), in which certain processes are blocked, even after a restart. This ensures that no function is carried out should a software upgrade fail.

The second processor 220 can be a BCP (body control processor) in some embodiments.

The processor system also comprises a third processor 230, which is connected to the first processor 210 via a heartbeat HB. For example, the third processor 230 may output a planned trajectory to electronic control units of corresponding actuators of a vehicle driving autonomously. The third processor 230 may implement a watchdog functionality. For example, the first processor 210 may stop the heartbeat HB in the case of a faulty update, with the result that the third processor 230 no longer outputs the planned trajectory. Alternatively, the third processor 230 may output a predetermined emergency trajectory instead of the planned trajectory.

At least some of the processors, especially the first processor 210 and the third processor 230, may be part of a certain platform, as indicated by the dashed line in FIG. 2.

FIG. 3 schematically shows a processor 300 for a vehicle according to embodiments of the present disclosure. The processor 300 may be included in the processor system according to the present disclosure or may form the processor system according to the present disclosure. In particular, the processor 300 may be the first processor 210 shown in FIG. 2.

The processor 300 comprises a machine state manager (MSM) module 310 configured to manage states in relation to processes 340. The machine state manager module manages various states for example of a software platform to which the processes belong. By way of example, the various states can be “init”, “running”, “shutdown”, and the predetermined state (e.g., “PlatformOnly”).

The processor 300 also comprises an execution manager (EM) module 320 configured to output an instruction for starting and stopping the processes 340. The execution manager module 320 controls the execution of the processes 340 by means of appropriate prompts PR by the machine state manager module 310. In particular, the execution manager module 320 is configured to start processes in accordance with the state specified by the machine state manager module 310.

The processor 300 also comprises a safety module 330 for remote software updates (remote software update degradation handler, RSU DH) configured to receive a degradation signal DS which specifies a failed remote software update.

In some embodiments, the safety module 330 may comprise a nonvolatile storage module 332 for storing the degradation signal DS. In particular, the degradation signal DS and/or information in relation to the failed remote software update may be stored in the nonvolatile storage module 332, with the result that this information still is available even in the case of a restart of the processor 300, and an activation of the blocked processes or functions is prevented.

Upon reception of the degradation signal DS, the safety module 330 is configured to output an instruction ST to the machine state manager module 310 instructing a change of the machine state manager module 310 to a predetermined state, with an execution of at least one process of the processes 340 not being allowed in the predetermined state. This is intended to ensure that no function is carried out should a software upgrade fail. In particular, the safety module 330 specifies whether the system should be and/or remain in the predetermined state. The machine state manager module 310 can query this information from the safety module and can accordingly bring the system into the predetermined state. Hence, the execution manager module 320 also knows which processes should/may be started.

The safety module 330 is further configured to receive a process list PL with started processes from the execution manager module 320 and output a termination signal PS to stop the at least one process should the process list PL comprise the at least one process. Preferably, a process list with processes which should/may be started in the predetermined state is stored in a configuration module (configuration time), for example of the safety module 330. The termination signal is output if the safety module 330 recognizes that a process not on the list of allowed processes has been started.

Hence, the safety module 330 monitors the blocking of certain processes, by virtue of the safety module 330 obtaining a list of started processes from the execution manager module 320, which is to say the module responsible for starting the processes. If the execution manager module 320 starts a different list of processes from what is allowed, the problem is reported, for example via a heartbeat HB, to a watchdog (not shown in FIG. 3). As a result, it is possible to reliably prevent an execution of certain processes if a remote software update has failed, whereby it is possible to minimize safety risks in the case of a failed remote software update.

In some embodiments, the processor 300 may further comprise a monitoring module 350 configured to receive the termination signal PS from the safety module 330 and initiate a shutdown and restart upon reception of the termination signal PS. For example, this can be implemented via the heartbeat HB.

In some embodiments, the machine state manager module 310 can be indicated by QM pursuant to standard ISO 26262. Additionally or alternatively, the execution manager module 320 can be indicated by ASIL A, ASIL B, ASIL C, or ASIL D pursuant to standard ISO 26262. Additionally or alternatively, the safety module 330 can be indicated by ASIL A, ASIL B, ASIL C, or ASIL D pursuant to standard ISO 26262. Additionally or alternatively, the monitoring module 350 can be indicated by ASIL A, ASIL B, ASIL C, or ASIL D pursuant to standard ISO 26262. Additionally or alternatively, the degradation signal DS can be indicated by ASIL A, ASIL B, ASIL C, or ASIL D pursuant to standard ISO 26262.

Hence, it is not necessary to qualify the entire life cycle management on the processor 300 having the machine state manager module 310, the execution manager module 320, the safety module 330, and the monitoring module 350, whereby it is possible to reduce costs. In particular, it is possible to implement only the (small) safety module 330, which indirectly monitors deviations from the expected state following an RSU degradation.

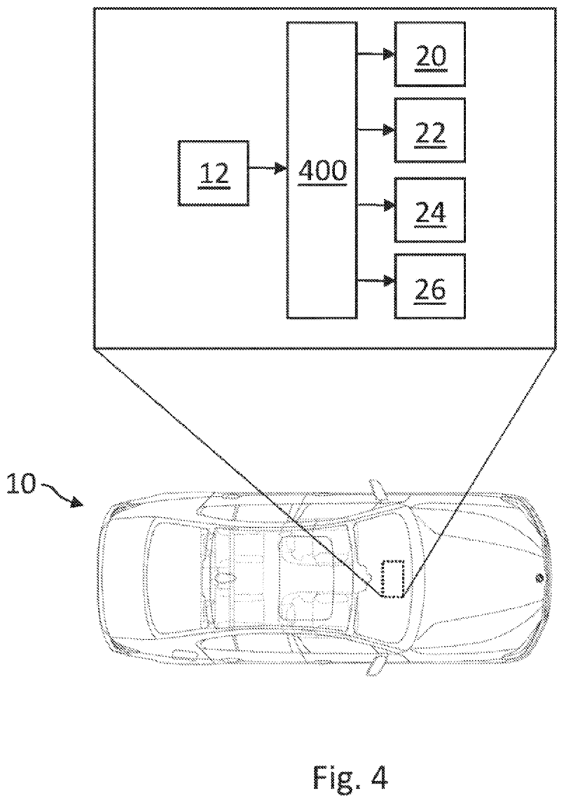

FIG. 4 schematically shows a vehicle 10 having a driver assistance system 400 for automated driving according to embodiments of the present disclosure.

The longitudinal and/or transverse guidance of the vehicle 10 is implemented automatically within the scope of automated driving. Thus, the driver assistance system 400 adopts the vehicle guidance. To this end, the driver assistance system 400 controls the drive 20, the transmission 22, the hydraulic service brakes 24, and the steering system 26 by way of intermediate units (not depicted).

To plan and carry out automated driving, surround information from a surround sensor system, which observes the vehicle surround, is received by the driver assistance system 400. In particular, the vehicle may comprise at least one surround sensor 12 configured to receive surround data specifying the vehicle surround. For example, the at least one surround sensor 12 may comprise a lidar system, one or more radar systems, and/or one or more cameras.

The driver assistance system 400 comprises the processor system according to the present disclosure. For example, the processor system may be configured for planning a trajectory for the automated driving.

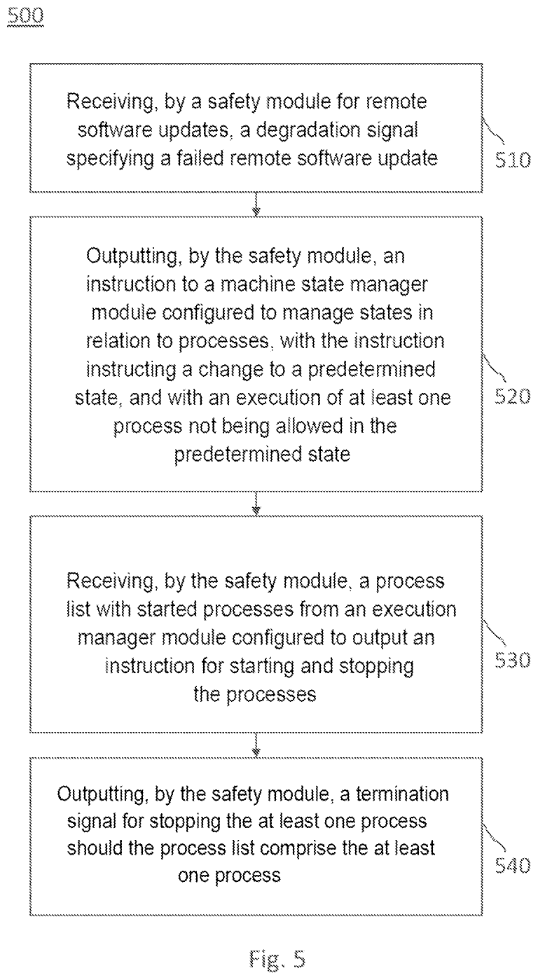

FIG. 5 schematically shows a flowchart of a method 500 for monitoring a process state following a remote software update according to embodiments of the present disclosure. The method 500 may be implemented by appropriate software, which is executable by one or more processors (e.g., a CPU).

The method 500 comprises, in block 510, receiving, by a safety module for remote software updates, a degradation signal specifying a failed remote software update; in block 520, outputting, by the safety module, an instruction to a machine state manager module configured to manage states in relation to processes, with the instruction instructing a change to a predetermined state, and with an execution of at least one process not being allowed in the predetermined state; in block 530, receiving, by the safety module, a process list with started processes from an execution manager module configured to output an instruction for starting and stopping the processes; and, in block 540, outputting, by the safety module, a termination signal for stopping the at least one process should the process list comprise the at least one process.

According to the present disclosure, the degradation signal is not transmitted directly to the machine state manager module but to a safety-relevant module which is responsible for triggering and monitoring the blocking of specific processes. The safety module then requests that the machine state manager module change its state to a predetermined state which is expected following the reception of a degradation signal on account of a failed remote software update. An execution of certain processes is not allowed in this state. The safety module monitoring of this blocking of certain processes is implemented by virtue of the safety module receiving a list of started processes from the execution manager module, which is to say the module responsible for starting the processes. Should the execution manager module start a different list of processes from what is allowed, the problem is reported to a watchdog, for example via a heartbeat. Hence, the safety module checks whether the state was correctly set by way of an “indirect measurement”. The configuration according to the present disclosure is particularly advantageous if the machine state manager module is not qualified (e.g., QM pursuant to standard ISO 26262).

As a result, an execution of certain processes can be reliably prevented in the case of a failed remote software update, whereby it is possible to minimize safety risks in the case of a failed remote software update.

Although the present disclosure has been explained and illustrated in more detail through preferred exemplary embodiments, the present disclosure is not restricted by the disclosed examples and other variations may be derived therefrom by a person skilled in the art without departing from the scope of protection of the present disclosure. It is therefore clear that there are a multiplicity of variable implementations. It is likewise clear that embodiments mentioned by way of example actually only constitute examples that should not be understood in any way as limiting for instance the scope of protection, the application options, or the configuration of the present disclosure. On the contrary, the above description and the description of the figures give a person skilled in the art the ability to implement the exemplary embodiments in specific terms, wherein a person skilled in the art with knowledge of the disclosed concept of the present disclosure may make numerous modifications, for example with regard to the function or the arrangement of individual elements mentioned in an exemplary embodiment, without departing from the scope of protection defined by the claims and their legal counterparts, such as for instance further explanations in the description.

1.-10. (canceled)

11. A processor system for a vehicle, comprising at least one processor in communication with a non-transitory computer readable memory storing a plurality of instructions that, when executed by the at least one processor, configure the at least one processor to:
manage states in relation to processes;
output an instruction for starting and stopping the processes;
receive a degradation signal specifying a failed remote software update;
change to a predetermined state, with an execution of at least one process not being allowed in the predetermined state;
receive a process list with started processes; and
output a termination signal for stopping the at least one process should the process list comprise the at least one process.

12. The processor system according to claim 11, further comprising a nonvolatile storage module, wherein the at least one processor is further configured to store the degradation signal in the nonvolatile storage module.

13. The processor system according to claim 1, wherein the at least one processor is further configured to:
receive the termination signal; and
initiate a shutdown of at least a part of the processor system upon reception of the termination signal.

14. The processor system according to claim 13, wherein the at least one processor is configured to initiate the shutdown by means of a heartbeat to a watchdog.

15. The processor system according to claim 11, wherein:
the managing of states of processes is indicated by QM pursuant to standard ISO 26262; and/or
the instruction for starting and stopping the process is indicated by ASIL A, ASIL B, ASIL C, or ASIL D pursuant to standard ISO 26262; and/or
the degradation signal specifying a failed remote software update is indicated by ASIL A, ASIL B, ASIL C, or ASIL D pursuant to standard ISO 26262.

16. The processor system according to claim 11, wherein the at least one processor is a single SoC-based processor.

17. The processor system according to claim 11, wherein the at least one process relates to a driving function for automated driving.

18. The processor system according to claim 11 further comprising a first processor and a second processor,
wherein the first processor sends the degradation signal to the at least one processor, and
wherein the second processor receives the termination signal for stopping the at least one process.

19. The processor system according to claim 18, wherein the second processor, upon execution of a second set of instructions, is configured to output a planned trajectory to electronic control units of corresponding actuators of a vehicle driving autonomously.

20. The processor system according to claim 18, wherein the second processor, in response to receiving the termination signal for stopping the at least one process, no longer outputs the planned trajectory.

21. The processor system according to claim 18, wherein the second processor, in response to receiving the termination signal for stopping the at least one process, outputs a predetermined emergency trajectory instead of the planned trajectory.

22. The processor system according to claim 18, wherein the second processor is connected to the at least one processor via a heartbeat.

23. A driver assistance system for automated driving of a vehicle, comprising the processor system according to claim 11.

24. A vehicle, in particular a motor vehicle, comprising the driver assistance system according to claim 23.

25. A method for monitoring a process state following a remote software update, comprising:
receiving a degradation signal specifying a failed remote software update;
outputting an instruction instructing a change to a predetermined state, and with an execution of at least one process not being allowed in the predetermined state;
receiving a process list with started processes; and
outputting a termination signal for stopping the at least one process should the process list comprise the at least one process.

26. The processor system according to claim 25, wherein the second processor receives the termination signal for stopping the at least one process via the at least one processor stopping the heartbeat.

27. The method according to claim 25, further comprising:
receiving the termination signal; and
initiating a shutdown of at least a part of the processor system upon reception of the termination signal.

28. The method according to claim 27, wherein the initiating the shutdown is performed by means of a heartbeat to a watchdog.

29. The method according to claim 27 further comprising:
outputting a planned trajectory to electronic control units of corresponding actuators of a vehicle driving autonomously; and
in response to receiving the termination signal, ceasing outputting of the planned trajectory.

30. The method according to claim 25 wherein the method is performed by a driver assistance system for automated driving of a vehicle.
